(19) United States
(12) Patent Application Publication
(10) Pub. No.: US 2026/0203591 A1
(43) Pub. Date: Jul. 16, 2026

(54) MULTIMODAL AUTOENCODER

(71) Applicant: Google LLC, Mountain View, CA (US)

(72) Inventors: Anurag Arnab, Grenoble (FR); Eduardo David Fonseca Montero, New York, NY (US); Mario Lucic, Adliswil (CH); Cordelia Luise Schmid, Saint Ismier (FR); Mariana-Iuliana Georgescu, Bucharest (RO)

(21) Appl. No.: 19/136,058

(22) PCT Filed: Dec. 6, 2023
(86) PCT No.: PCT/US2023/082659

§ 371 Date: Jun. 5, 2025

(30) Foreign Application Priority Data
Dec. 7, 2022 (EP) 22290066.4

(51) Int. Cl. G06N 3/0895; G06N 3/0455

(52) U.S. Cl. CPC G06N 3/0895; G06N 3/0455

(57) ABSTRACT

A method, a system, or one or more computer-readable storage media for training a machine learning model. The method includes receiving multiple training examples, each having a set of unmasked tokens for a first modality and a set of unmasked tokens for a second modality. For each training example, an encoder processes the sets of unmasked tokens for the first modality and the second modality to generate a set of embedded tokens for the first modality. A decoder processes at least the set of embedded tokens to reconstruct a set of masked tokens for the first modality. A loss is determined based on the reconstructed set of masked tokens and a set of masked tokens for the first modality according to an objective function, which is optimized to decrease the losses for the multiple training examples. The model parameters of the machine learning model are updated based on the optimization.

### BACKGROUND

This specification relates to systems and methods for training a multimodal autoencoder.

Machine learning is a type of artificial intelligence that aims to teach computers how to learn and act without necessarily being explicitly programmed. More specifically, machine learning is an approach to data analysis that involves building and adapting models, which allow computer-executable programs to “learn” through experience. Machine learning involves the design of algorithms that adapt their models to improve their ability to make predictions. This is done by training a machine learning model using historical data (training data) for which the outcome (label) is known, called supervised learning. In some cases, a machine learning model is compatible with unsupervised learning or self-supervised learning, where there are few or no labeled training examples for the training process. The computer may identify rules or relationships during the training period and learn the learning parameters of the machine learning model. Then, using new inputs, the machine learning model can generate a prediction based on the identified rules or relationships.

### SUMMARY

This specification generally describes systems and methods for training a multimodal autoencoder. The multimodal can include multiple modalities, such as a first modality for audio data and a second modality for video data. The multimodal autoencoder receives unmasked tokens as input for different modalities. The multimodal autoencoder is configured to reconstruct the original tokens or masked tokens for one or more modalities by processing the received unmasked tokens for one or more modalities. That is, a particular data item may comprise a plurality of tokens. The plurality of tokens may be filtered or “masked” to notionally remove tokens from the set of tokens. The tokens that are selected for removal may be referred to as “masked” tokens whilst the remaining tokens may be referred to as “unmasked” tokens. The multimodal autoencoder includes an encoder and a decoder. The encoder and the decoder can have a few different structures to process multimodal inputs. The described multimodal autoencoder is also called a multimodal masked autoencoder (MAE) in some implementations. However, one should note that not all multimodal autoencoders need to perform a masking step over input tokens. Thus, for the purposes of simplicity and as a reminder, the following description generally calls it a “multimodal autoencoder” or MAE.

In one aspect, a method for training a machine learning model, includes: receiving multiple training examples for training a machine learning model, wherein each of the multiple training examples includes a set of unmasked tokens for a first modality and a set of unmasked tokens for a second modality; for each training example of the multiple training examples: processing, by an encoder of the machine learning model, the set of unmasked tokens for the first modality of the training example and the set of unmasked tokens for the second modality of the training example to generate a set of embedded tokens for the first modality; processing, by a decoder of the machine learning model, at least the set of embedded tokens for the first modality to reconstruct a set of masked tokens for the first modality; and determining a loss based on the reconstructed set of masked tokens for the first modality and a set of masked tokens for the first modality according to an objective function; and updating model parameters of the machine learning model by optimizing the objective function to decrease the losses for the plurality of training examples. Other aspects include systems and software storing instructions that cause systems to perform the operations of the above-described method.

In some implementations, the techniques to generate the multiple training examples include receiving multiple input examples, wherein each of the multiple input examples includes a first portion for a first modality and a second portion for a second modality, and generating a training example for each of the multiple input examples. The process for generating the training example can include masking the first portion of the first modality for the input example to generate the set of masked tokens for the first modality and the set of unmasked tokens for the first modality, and masking the second portion of the second modality for the input example to generate a set of masked tokens for the second modality and a set of unmasked tokens for the second modality.

To reconstruct the set of masked tokens for the first modality, the system can process, by the decoder of the machine learning model, (i) the set of embedded tokens for the first modality and (ii) a set of masked tokens for the second modality to reconstruct the set of masked tokens for the second modality. Alternatively, the system can process, by the decoder of the machine learning model, (i) the set of embedded tokens for the first modality and (ii) a set of embedded masked tokens for the second modality generated by the encoder for the training example to reconstruct the set of masked tokens for the first modality or the second modality.

In some cases, the described techniques are configured to process two modalities. The first modality can be a video modality, and the second modality can be an audio modality. Alternatively, the first modality can be an audio modality, and the second modality can be a video modality.

The input examples can each include a video input and a corresponding audio input, for example, one input example can be a video clip with a corresponding audio track. The described techniques can process a sequence of images for a sequence of time steps, and a corresponding audio spectrogram for the time steps. In some implementations, the system can directly process the raw audio track associated with the video input.

In general, the encoder in the machine learning model can have different structures for different training requirements or purposes. For example, the encoder can include a joint transformer configured to process sets of unmasked tokens for the first modality and corresponding sets of unmasked tokens for the second modality to generate embedded tokens for the first and second modalities. As another example, the encoder can have a first transformer configured to process sets of unmasked tokens for the first modality to generate embedded tokens for the first modality, and a second transformer configured to process sets of unmasked tokens for the second modality to generate embedded tokens for the second modality. As another example, the encoder can have a transformer with parameters, wherein the transformer is configured to process, for a first time period, sets of unmasked tokens for the first modality using the parameters to update the parameters and generate embedded tokens for the first modality, and the transformer is configured to process, for a second time period, sets of unmasked tokens for the second modality using the updated parameters to update the parameters and generate embedded tokens for the second modality. As another example, the encoder can include a first transformer to process sets of unmasked tokens for the first modality to generate first intermediate results, a second transformer to process sets of unmasked tokens for the second modality to generate second intermediate results; and a joint transformer to process the first and second intermediate results to generate embedded tokens for the first and second modalities.

Similarly, the decoder in the machine learning model can have different structures similar to that of the encoder. For example, the decoder can include a joint transformer configured to process sets of embedded tokens for the first modality and corresponding sets of unmasked tokens for the second modality to reconstruct corresponding sets of masked tokens for the first modality and the second modality. As another example, the decoder can include a first transformer configured to process sets of embedded tokens for the first modality to reconstruct corresponding sets of masked tokens for the first modality and a second transformer configured to process sets of embedded tokens for the second modality to reconstruct corresponding sets of masked tokens for the second modality. As another example, the decoder can include a transformer with parameters, wherein the transformer is configured to process, for a first time period, sets of embedded tokens for the first modality using the parameters to update the parameters and reconstruct corresponding sets of masked tokens for the first modality, the transformer is configured to process, for a second time period, sets of embedded tokens for the second modality using the updated parameters to update the parameters and reconstruct corresponding sets of masked tokens for the second modality. As another example, the decoder can include a first transformer to process sets of embedded tokens for the first modality to generate first intermediate reconstruction results, a second transformer to process sets of embedded tokens for the second modality to generate second intermediate reconstruction results, and a joint transformer to process the first and second intermediate reconstruction results to generate corresponding unmasked tokens for the first and second modalities.

The machine learning model can pick one from multiple different structures as a structure for the encoder and a structure for the decoder compatible with the encoder and for processing inputs having multiple modalities.

The objective function for the training can be defined based on a Mean-Square-Error (MSE) function, L1 error function, Huber error function, or other suitable functions for the first and second modalities. The object function can be different for different training schemes.

The masking (process) can be performed by a predetermined algorithm. For example, the system can execute a masking algorithm to randomly select patches of inputs for the first modality, the second modality, or both to be masked out. The masking ratio can range from 50% to 90% for different modality types. In addition, for encoders or decoders including a transformer, the masking algorithm can further include a token ID and a corresponding positional embedding for each input token (or patch). The transformer is configured to process a sequence of tokens simultaneously using the positional embedding.

After the machine learning model has been trained, the described techniques can further fine-tune the trained encoder using multiple fine-tuning examples. For example, the described method or system can receive multiple fine-tuning examples, each fine-tuning example including a portion for the first modality, or a portion for the second modality, or both; and update parameters of the encoder. The updating process can include processing each of the multiple fine-tuning examples using the encoder to generate a prediction; and updating the parameters of the encoder by optimizing a second objective function using the predictions and reference outputs.

The subject matter described in this specification can be implemented in particular embodiments so as to realize one or more of the following advantages. By establishing a machine learning model to process inputs with multiple modalities, the described techniques can improve the efficiency of learning more accurate and optimized representations of inputs than using a machine learning model capable of processing inputs with a single modality. The more accurate and optimized representations can further benefit one or more downstream tasks, as they can improve the prediction accuracy and the efficiency of generating predictions.

In addition, the described techniques are robust to different machine learning tasks or requirements because the described techniques can include a few different structures for the encoder and the decoder in the multi-modal model. A system or a method can have multiple combinations for the encoder structure and the decoder structure to achieve goals for different machine learning tasks.

Furthermore, the described techniques implement masking techniques to decrease the input size for processing, which facilitates the training process by reducing the computational cost and the memory bandwidth requirement. In addition, the encoder or the decoder can include a transformer using self-attention techniques to process a sequence of unmasked tokens for different modalities efficiently.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a block diagram of an example multimodal autoencoder.

FIG. 2 illustrates an example masking process for generating inputs for a multimodal autoencoder.

FIGS. 3A-D each illustrates an example encoder of a multimodal autoencoder.

FIG. 4 illustrates a flow diagram illustrating an example process for training a multimodal autoencoder.

FIG. 5 illustrates a block diagram of an example computer system.

Like reference numbers and designations in the various drawings indicate like elements.

### DETAILED DESCRIPTION

The techniques described herein generally relate to a multimodal autoencoder. The described multimodal autoencoder is configured to receive input data (e.g., unmasked tokens) for different modalities (e.g., audio, visual, or textual, etc.) and reconstruct the input data. The described multimodal autoencoder can include an encoder and a decoder. The encoder is configured to process input tokens (e.g., unmasked tokens) to generate embedded or encoded tokens. The decoder is configured to process the encoded tokens to generate reconstructed data corresponding to the input data. The encoder is configured to have different structures or arrangements for fulfilling different requirements of different tasks. The decoder can be configured with structures similar to the encoder. However, the decoder can also be configured to have different structures (e.g., a more simplified structure with fewer layers and smaller layer size or with different layer types) for different tasks. The encoder and decoder are generally trained jointly on the same input data according to an objective function (e.g., a loss function). Model parameters of the encoder and the decoder are updated jointly by optimizing the objective function (e.g., minimizing losses according to the loss function). As described in more detail below, an input data can be divided into multiple non-overlapping patches (e.g., multiple image or audio patches of original image or audio spectrum). In some implementations, a token may be a patch of an input data (e.g., an image, frame of video or spectrogram representation of an audio signal). Alternatively, a token can be converted from a patch of an input data by different techniques, e.g., linear projection, non-linear projection, or other suitable conversion techniques. For ease of illustration, the techniques are described below in connection with tokens. However, one should note that the described techniques can process data patches as input directly or convert patches into tokens as input candidates.

In some implementations, a multimodal autoencoder is also called a multimodal masked autoencoder. However, the specification described herein distinguishes the two terms. In general, a multimodal masked autoencoder can include a multimodal autoencoder that is used with or itself includes a mask for filtering out a portion of an input. For example, a mask can divide an input image into multiple tokens, some of which are filtered out by the mask (also referred to as masked tokens). The multimodal autoencoder receives only the unmasked input image tokens as input. One should note that the multimodal autoencoder described in this specification does not necessarily perform one or more masking operations on original input data. Nonetheless, for ease of illustration and description, a multimodal autoencoder with or without performing the masking operations is generally referred to as a multimodal autoencoder (MAE) below.

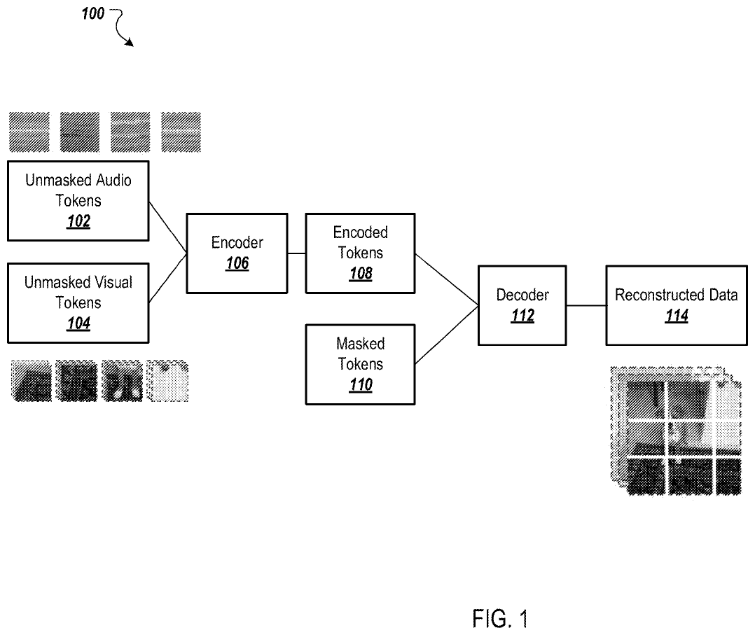

FIG. 1 illustrates a block diagram of an example multimodal autoencoder 100. The multimodal autoencoder 100 includes an encoder 106 and a decoder 112. The encoder 106 is configured to receive and process the input of more than one modality and generate encoded data for the input. A modality generally relates to a type or genre of data, e.g., audio data, visual data, or textual data, where each of the audio data, visual data, and textual data are data of different respective modalities. Data with multiple modalities can, for example, include a video including a soundtrack, a video including a sequence of subtitles, or a video including both the soundtrack and the sequence of subtitles. As another example, multimodal data can include an image with a title describing the image, a text with an accompanying soundtrack, or other suitable multimodal data.

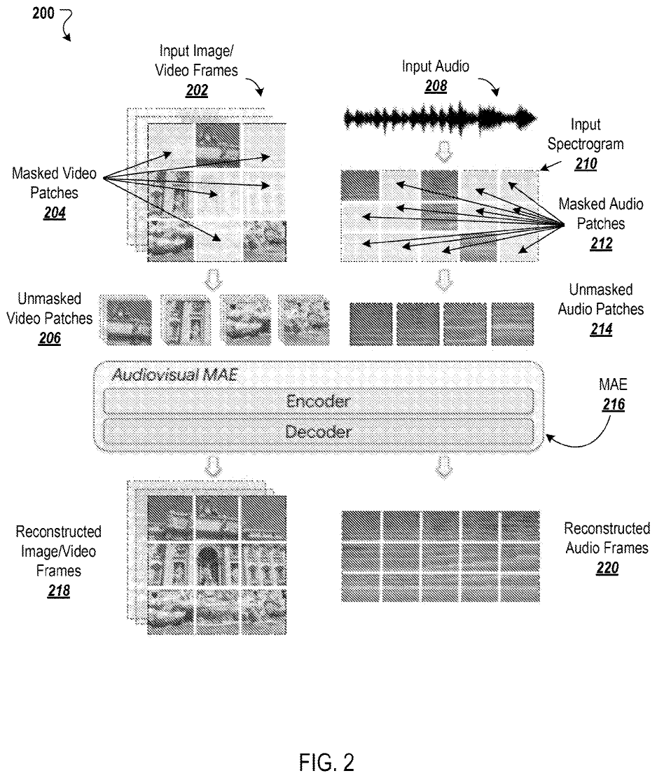

As shown in FIG. 1, encoder 106 is configured to process unmasked audio tokens 102 and unmasked visual tokens 104 and generate encoded tokens 108 for the unmasked audio tokens 102 and unmasked visual tokens 104. As described above, unmasked tokens can be described by performing one or more filtering operations on the original input data. In some implementations, original input data can be pre-processed by one or more operations to form non-overlapping tokens (e.g., converted from patches), and then one or more masking operations are applied over the non-overlapping tokens. More details of the masking process are described below in connection with FIG. 2.

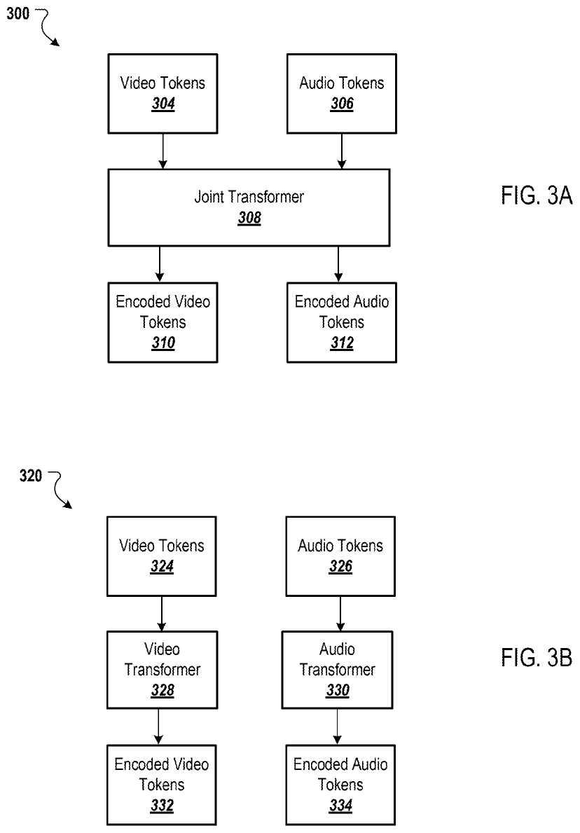

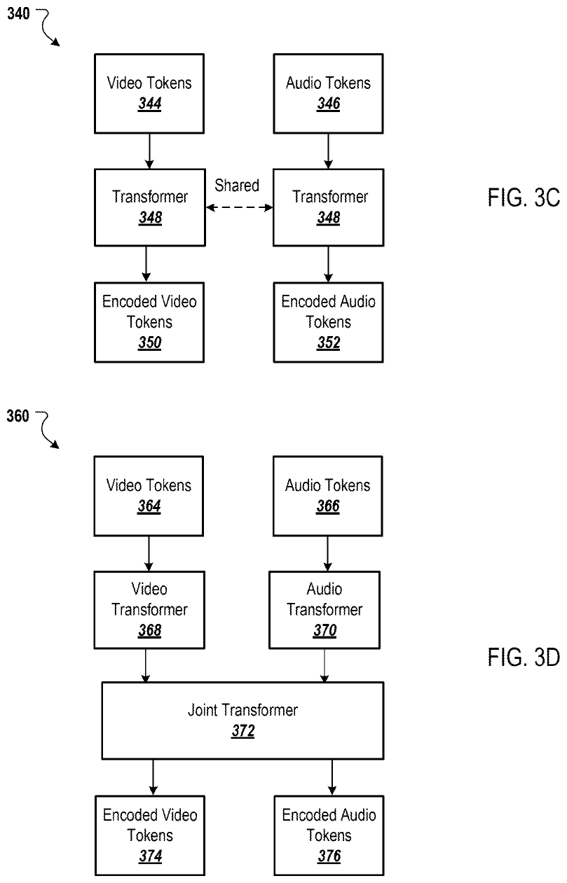

In addition, encoder 106 can be configured to have different structures for fulfilling different requirements raised by different machine learning tasks. For example, encoder 106 can include one or more transformers. A transformer is a particular type of encoder that is capable of efficiently processing sequential input data (e.g., words in a sentence, a sequence of audio data, or a sequence of images) in parallel rather than sequentially. In general, a transformer implements a self-attention mechanism to encode position information of data and associate the position information with individual data in the sequence such that the transformer can process the input embedded with position information in parallel. One or more layers in a transformer include a multi-head self-attention layer for encoding the position information, which is followed by an addition and normalization layer for stabilizing the training process and facilitating the flow of information through the network layers. More details of the structures of encoder 106 are described below in connection with FIGS. 3A, 3B, 3C, and 3D. Decoder 112 is configured to process both the encoded tokens 108 generated by encoder 106 and masked tokens 110 for a particular type of modality for generating reconstructed data 114. For example, the masked token 110 can belong to a first modality (e.g., visual input data), a second modality (e.g., audio input data), or a third modality (e.g., textual input data).

The reconstructed visual data 114 can, for example, include a sequence of image frames of a puppy. In this example, the unmasked visual tokens 104 can include tokens of an original sequence of image frames of the puppy, and unmasked audio tokens 102 can include tokens of a spectrogram representing a soundtrack accompanying with the original sequence of image frames of the puppy.

Decoder 112 is configured to generate output data including reconstructed data 114 for input of the same type of modality as the masked tokens 110. For example, as shown in FIG. 2, decoder 112 can process the encoded tokens 108 and mask tokens 110 for the original input visual data to generate reconstructed visual data 114 for the original input visual data. Alternatively (yet not shown in FIG. 1), decoder 112 can process the encoded tokens 108 and masked tokens 110 for the original input audio data to generate reconstructed audio data 114 for the original input audio data.

In some implementations, decoder 112 can be configured to generate reconstructed data 114 with a modality different from that of the masked tokens 110. For example, the reconstructed data 114 can have a visual modality, whereas the masked tokens 110 can have an audio modality, and vice versa.

Decoder 112 can even generate reconstructed data 114 by processing only encoded tokens 108 and without processing masked tokens 110. In these implementations, decoder 112 can generate reconstructed data representing the visual modality, the audio modality, or both.

FIG. 2 illustrates an example masking process 200 for generating inputs for a multimodal autoencoder. For simplicity, the multimodal autoencoder (MAE) 216 is generally similar or equivalent to multimodal autoencoder 100 of FIG. 1. The unmasked video patches 206 are similar or equivalent to the unmasked visual tokens 104 of FIG. 1. The unmasked audio patches 214 are similar or equivalent to the unmasked audio tokens 102 of FIG. 1. The masked video patches 204 and masked audio patches 212 are similar or equivalent to masked tokens 110 of FIG. 1. The reconstructed image/video frames 218 or the reconstructed audio frames 220 are similar or equivalent to the reconstructed data 114 of FIG. 1.

Input data to the described MAE are data that can be converted into a sequence of tokens. For example, image input data can be tokenized by performing a linear projection of non-overlapping “patches” of the input image. Such a linear projection is similar or equivalent to a two-dimensional convolution. As another example, video input data can be tokenized by linearly projecting spatio-temporal “tubelets.” Such “tubelet” linear projection is similar or equivalent to a three-dimensional convolution.

Audio inputs are generally transformed from the time domain into the frequency domain using Fourier transformation to generate spectrograms. For example, input audio 208 can be converted into an input spectrogram with a sequence of tokens. Spectrograms are generally two-dimensional representations along both the time and frequency axis in the Fourier domain. Thus, spectrograms can be treated as images with a single channel, and can be processed by image neural networks efficiently, e.g., the ImageNet model.

As shown in FIG. 2, input image/video frames 202 can be converted into a sequence of tokens, which are represented by small patches in FIG. 2. A mask or module(s) can be configured to process the sequence of tokens to generate a set of unmasked video patches 206 and a set of masked video patches 204. Similarly, the mask or module(s) can be configured to process the sequence of spectrogram 210 to generate a set of unmasked audio patches 214 and a set of masked audio patches 212. The set of unmasked video patches 206 and the set of unmasked audio patches 214 are provided to MAE 216 for reconstructing the original audio or video input, or both. In some implementations, the masked video patches 204 or the masked audio patches 212 are also provided as input to MAE 216 for reconstructing the original input data. The type of modality of the masked patches can be the same as that of the reconstructed data, as described above.

From a theoretical framework, the input can include an original input (e.g., an image frame or an audio track) or a patch of multiple non-overlapped patches generated from the original input. The input can be defined as x and be further tokenized using standard supervised machine learning setups for training examples, e.g., each training example includes a pair of measured data and their respective reference or label. The input x can be converted into tokens as below:

$$\\ \begin{matrix}v = Tokenize ( x ) + p , & Equation ( 1 )\end{matrix}$$

where p denotes corresponding positional embeddings. v∈ [symbol] ^{n×d}, where n is the total number of tokens, and d represents hidden dimensionality for these tokens. The masking operations can be performed using different algorithms. For example, a subset of the n tokens may be randomly selected to be masked out, and only the unmasked tokens are processed by the transformer encoder (or MAE 216). For example, the unmasked tokens can be expressed as below:

$$\\ \begin{matrix}u = Mask ( v ; α ) , & Equation ( 2 )\end{matrix}$$

where u represents the unmasked tokens of a particular sequence of tokens v, the term “α” generally relates to a predetermined masking ratio, which can range from 0 to 1, and Mask( ) is a function that applies masking to v according to masking ratio α. The size or length of unmasked tokens u can be represented as below

$$\\ \begin{matrix}\vert u \vert = ( 1 - α ) \times n , & Equation ( 3 ) .\end{matrix}$$

The transformer encoder or MAE is configured to encode the unmasked tokens u to generate embedded or encoded tokens e for u. Encoded tokens e can be similar or equivalent to encoded tokens 108 of FIG. 1.

The masked tokens, on the other hand, can be represented by m, which shares the same real space as the unmasked tokens, i.e., [symbol] ^{n×d}. As described in FIG. 1, the masked tokens m and the encoded unmasked tokens e can be concatenated to form an input token sequence as below:

$$\\ \begin{matrix}z = Unshuffle ( e , m ) ∈ {ℝ}^{n \times d} , & Equation ( 4 )\end{matrix}$$

The Unshuffle(*) function generally refers to a function of concatenation. For example, the masked tokens m can be appended to the encoded unmasked tokens e without shuffling the position information.

Finally, a transformer decoder of the MAE can be configured to process the input tokens z. As described above, the transformer decoder can have a structure mirroring the structure of the transformer encoder. Alternatively, the transformer decoder can have different structures, e.g., lighter/shallower/smaller neural network structures than the encoder.

The entire network (e.g., the MAE 216) can be trained jointly on the same set of input training data. For each input sample with different modalities, the MAE 216 is configured to generate reconstructed input \tilde{x}, and the loss function can be determined by a reconstruction error between the reconstructed input \tilde{x} and the reference input x, for example a mean-squared error. Note that both \tilde{x} and x refer to the “tokenized” data generated by the operations described above.

FIG. 3A illustrates an example encoder 300 of a multimodal autoencoder. The example encoder 300 is similar or equivalent to encoder 106 of FIG. 1. Encoder 300 includes a joint transformer 308 configured to process input data with different modalities. For example, encoder 300 is configured to process video tokens 304 and audio tokens 306 jointly. Encoder 300 can generate encoded video tokens 310 for video tokens 304 and generate encoded audio tokens 312 for audio tokens. Encoder 300 is also referred to as “early fusion” encoder because the audio tokens 306 and video tokens 304 are fused together before passing to the transformer. The tokens can be fused together by, e.g., concatenation. Due to the high masking ratios, αₐ and αᵥ, for masking audio tokens and video tokens, encoder 300 is computationally efficient and enables the encoder to model joint interactions between different modalities, e.g., the audio and video modalities.

FIG. 3B illustrates an example encoder 320 of a multimodal autoencoder. The example encoder 320 is similar or equivalent to encoder 106 of FIG. 1. This variant of encoder 320, in contrast to the “early fusion” encoder 300 of FIG. 3A, encodes audio and video tokens with two separate encoders with respective parameters. Encoder 320, as shown in FIG. 3B, includes a video transformer 328 configured to process video tokens 324 to generate encoded video tokens 332. Encoder 320 further includes an audio transformer 330 configured to process audio tokens 326 to generate encoded audio tokens 334. For implementations where encoder 320 is used, a “late fusion” of audio and video is performed in a corresponding decoder when reconstructing the input tokens. Thus, encoder 320 is also referred to as a “late fusion” or “separate” encoder. Nonetheless, encoder 320 is advantageous because it enables a system to train separate encoders for each modality of different modalities at the same time. These trained encoders are also called pre-trained encoders, which can be configured to encode input from different modalities. In addition, these pre-trained encoders can be fine-tuned for a particular machine learning task. For example, a pre-trained encoder can be originally trained to encode a person captured in a video and his speech, and the pre-trained encoder can be fined-tuned to encode animals captured in a video and the corresponding sound made by these animals. Encoder 320 can be further helpful in downstream operations that require only a unimodal (e.g., audio-only or video-only) encoder. For example, a downstream task can relate to natural language processing, where the encoder is originally pre-trained to encode a text in English and can be fine-tuned to encode another text in Chinese.

FIG. 3C illustrates an example encoder 340 of a multimodal autoencoder. Encoder 340 is configured to include a transformer 348 for processing input with different modalities. More specifically, the parameters of transformer 348 are shared by different modalities. For example, transformer 348 is configured to, at a first time point, process video tokens 344 to generate encoded video tokens 350 using transformer parameters. At a second time point, transformer 348 uses the same transformer parameters to process audio tokens 346 and generates encoded audio tokens 352. This can be equivalent to encoder 320 of FIG. 3B because the transformer parameters are inherently associated with transformers. However, due to the different setups in encoders, the training process can be drastically different, leading to different transformer parameters and encoder performance. Accordingly, encoder 320 and encoder 340 can be categorized differently.

FIG. 3D illustrates an example encoder 360 of a multimodal autoencoder. Encoder 360 includes a video transformer 368 configured to process video tokens 364 to generate intermediate video output. Encoder 360 further includes an audio transformer 370 configured to process audio tokens 366 to generate intermediate audio output. Encoder 360 further includes a joint transformer 372 configured to process the intermediate video output and audio output to generate encoded video tokens 374 and encoded audio tokens 376. In some implementations, the audio transformer 370 and video transformer 368 can be a first set of layers in a transformer, and the rest of the layers in the transformer form the joint transformer 372. For example, video transformer 368 and audio transformer 370 can constitute the first L layers in the transformer. Here, video transformer 368 can be the first S layers of the first L layers, and audio transformer 370 can be the first (L-S) layers. The intermediate audio output and video output are fused together (e.g., concatenated) to form a single sequence of tokens, which are then provided as input for the rest of the layers of the transformer (i.e., joint transformer 372). Encoder 360 is also referred to as “mid fusion,” to distinguish from “early fusion” encoder 300 and “late fusion” encoder 320.

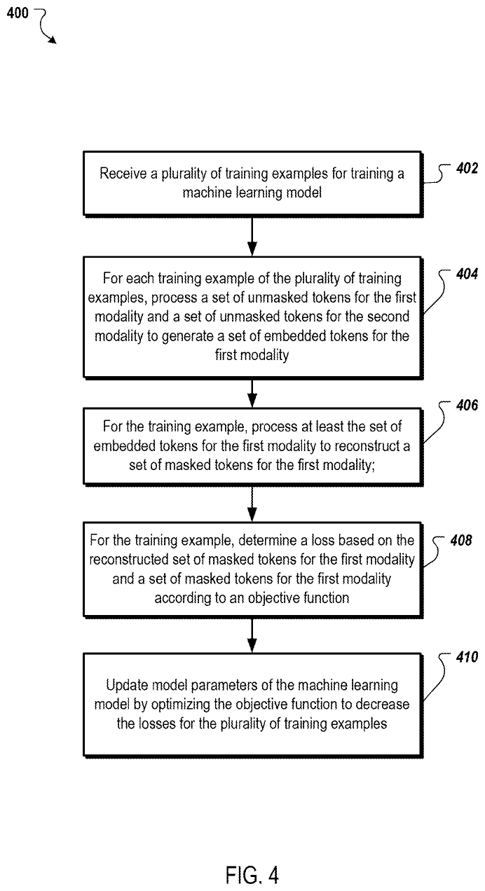

FIG. 4 illustrates a flow diagram illustrating an example process 400 for training a multimodal autoencoder. Operations of process 400 can be implemented, for example, by the multimodal autoencoder 100 of FIG. 1 or MAE 216 of FIG. 2. Operations of process 400 can also be implemented as instructions stored on one or more computer-readable media, which may be non-transitory, and the execution of the instructions by one or more data processing apparatuses can cause the one or more data processing apparatuses to perform the operations of the process 400.

To train the multimodal autoencoder described herein, the system receives a plurality of training examples (402). Each of the plurality of training examples includes a set of unmasked tokens for a first modality and a set of unmasked tokens for a second modality. For example, the first modality can be a video modality, and the second modality can be an audio modality. As another example, the first modality can be an audio modality and the second modality can be a video modality. In some implementations, the modalities can include other suitable modalities such as a textual modality.

In addition, one of the plurality of input examples can include a video input and a corresponding audio input. The audio input may include a raw audio track or a spectrogram generated from the raw audio track.

The training examples are generated by implementing one or more masking operations. More specifically, original input can be converted into a sequence of tokens. One or more masking operations or a mask can be applied over the sequence of tokens to generate a subset of tokens that are not masked or filtered out by the masking operations. The filtered tokens are also referred to as masked tokens, which could be used for decoding operations.

For each training example of the plurality of training examples, the system processes the set of unmasked tokens for the first modality of the training example and the set of unmasked tokens for the second modality of the training example to generate a set of embedded tokens for the first modality (404).

The operations can be performed by an encoder of the system. The encoder generally processes the input unmasked tokens of different modalities and generates corresponding encoded tokens for these modalities.

The encoder can have different structures for different task requirements. For example, the encoder can include a joint transformer configured to process sets of unmasked tokens for the first modality and corresponding sets of unmasked tokens for the second modality to generate embedded tokens for the first and second modalities. This encoder is also referred to as the “early fusion” encoder, as described above.

As another example, the encoder can include a first transformer configured to process sets of unmasked tokens for the first modality to generate embedded tokens for the first modality; and a second transformer configured to process sets of unmasked tokens for the second modality to generate embedded tokens for the second modality. This encoder is also referred to as the “late fusion” encoder, as described above.

As another example, the encoder can include a transformer with parameters, wherein the transformer processes, for a first time period, sets of unmasked tokens for the first modality using the parameters to update the parameters and generate embedded tokens for the first modality. Then, the transformer processes, for a second time period, sets of unmasked tokens for the second modality using the updated parameters to generate embedded tokens for the second modality. This encoder is also referred to as the “shared” encoder, as described above.

Yet as another example, the encoder can include a first transformer, a second transformer, and a joint transformer. The first transformer processes sets of unmasked tokens for the first modality to generate first intermediate results. The second transformer processes sets of unmasked tokens for the second modality to generate second intermediate results. The joint transformer processes the first and second intermediate results to generate embedded tokens for the first and second modalities. In some implementations, the first transformer and the second transformer can constitute the first multiple layers of a transformer and the joint transformer is formed by the rest of the layers of the transformer. This encoder is also referred to as the “mid-fusion” encoder, as described above.

The system processes at least the set of embedded tokens for the first modality to reconstruct a set of masked tokens for the first modality. More specifically, a decoder of the system processes at least the set of embedded tokens. The decoder, in some implementations, can process unmasked tokens of a particular modality for generating reconstructed data for the particular modality, as described above.

More specifically, the decoder processes (i) the set of embedded tokens for the first modality and (ii) a set of masked tokens for the second modality to reconstruct the set of masked tokens for the second modality. In some implementations, the decoder might not process the masked tokens. Instead, the decoder can process (i) the set of embedded tokens for the first modality, and (ii) a set of embedded masked tokens for the second modality generated by the encoder for the training example to reconstruct the set of masked tokens for the first modality or the second modality.

The decoder can have different structures for different purposes. For example, the decoder can have a structure that is simpler, shallower, or smaller than that of the encoder for efficiency. In some cases, the decoder can have a structure similar to that of the encoder in the system. For example, the decoder can include a joint transformer configured to process sets of embedded tokens for the first modality and corresponding sets of unmasked tokens for the second modality to reconstruct corresponding sets of masked tokens for the first modality and the second modality.

As another example, the decoder can include a first transformer configured to process sets of embedded tokens for the first modality to reconstruct corresponding sets of masked tokens for the first modality, and a second transformer configured to process sets of embedded tokens for the second modality to reconstruct corresponding sets of masked tokens for the second modality.

As another example, the decoder can include a transformer with parameters. The transformer is configured to process, for a first time period, sets of embedded tokens for the first modality using the parameters to update the parameters and reconstruct corresponding sets of masked tokens for the first modality. The transformer is configured to process, for a second time period, sets of embedded tokens for the second modality using the updated parameters to update the parameters and reconstruct corresponding sets of masked tokens for the second modality.

Yet as another example, the decoder can include a first transformer, a second transformer, and a joint transformer. The first transformer processes sets of embedded tokens for the first modality to generate first intermediate reconstruction results. The second transformer processes sets of embedded tokens for the second modality to generate second intermediate reconstruction results. The joint transformer processes the first and second intermediate reconstruction results to generate corresponding unmasked tokens for the first and second modalities.

In general, the above-described transformer can include different models for different tasks. For example, the transformer can include a vision transformer, e.g., the ViT-Base or ViT-Large models, further details of which can be found in Dosovitskiy et al., “An Image is Worth 16×16 Words: Transformers for Image Recognition at Scale”, in ICLR 2021, which is hereby incorporated by reference in its entirety. As another example, the transformer can include the audio-spectrogram transformer (the AST model) for audio input. Yet as another example, the transformer can include the video vision transformer (the ViViT model) for video input.

The system determines a loss based on the reconstructed set of masked tokens for the first modality and a set of masked tokens for the first modality according to an objective function (408). The objective function may be defined based on one of the Mean-Square-Error (MSE) function, L1 error function, or Huber error function for the first and second modalities.

More specifically, after encoding the unmasked tokens, the system combines the masked tokens of a particular modality into the sequence of encoded unmasked tokens to generate inputs for the decoder. The combined sequence can include features for different modalities (e.g., the audio modality and video modality). For example, the audio modality and the video modality can be expressed as zₐ∈ [symbol] ⁿ^{ₐ}^{×d} and zᵥ∈ [symbol] ⁿ^{ᵥ}^{×d}, respectively. Accordingly, one example loss function for audio modality can be expressed as below:

$$\\ \begin{matrix}{L}_{a} ( {z}_{a} , {\tilde{x}}_{a} ) = \frac{1}{{α}_{a} {n}_{α}} {\sum }_{i ∈ {M}_{a}} {‖ Decode ( {z}_{a} , i ) - {\tilde{x}}_{a , i} ‖}^{2} , & Equation ( 5 )\end{matrix}$$

where Mₐ denotes the set of mask token indices, since the system only computes the reconstruction loss on the masked tokens. Alternatively or in addition, the system can also compute the reconstruction loss for all tokens. Similarly, the reconstruction loss function for the video modality can take the same form as equation (5) with the subscription a being replaced with v, i.e., Lᵥ(zᵥ, \tilde{x}ᵥ). The joint loss function can be a weighted sum of loss functions for different modalities. For example, a joint loss function L can be an equally weighted sum of the audio modality loss function and video modality loss function, which is expressed below:

$$\\ \begin{matrix}L = 0.5 \times {L}_{a} ( {z}_{a} , {\tilde{x}}_{a} ) + 0.5 \times {L}_{v} ( {z}_{v} , {\tilde{x}}_{v} ) . & Equation ( 6 ) .\end{matrix}$$

The above-discussed objective function or the joint loss function L, aims to encourage stronger coupling between the two different modalities by reconstructing one modality from the other. As shown in FIG. 1, the system reconstructs the input video tubelets using the encoded audio tokens and masked video tokens. Similarly, the system can reconstruct the input audio tokens using the encoded video tokens and masked audio tokens, as described above. In addition, at least the above-described “early fusion” encoder 300 of FIG. 3A and “Mid-fusion” encoder 360 of FIG. 3D can be implemented with the above-noted objective function or joint loss function.

The system updates the model parameters of the machine learning model by optimizing the objective function to decrease the losses for the plurality of training examples (410). In general, the network parameters are repeatedly updated by minimizing the losses for each batch of training examples. The network parameters can be updated by gradient descent.

In some implementations, the system can be configured to generate a plurality of training examples. For example, the system can receive a plurality of input examples. Each of the plurality of input examples includes a first portion for a first modality and a second portion for a second modality. The system is configured to generate a training example for each of the plurality of input examples. To generate the training example, the system first masks the first portion of the first modality for the input example to generate the set of masked tokens for the first modality and the set of unmasked tokens for the first modality. The system then masks the second portion of the second modality for the input example to generate a set of masked tokens for the second modality and a set of unmasked tokens for the second modality.

The masking operations can be performed according to a pre-determined algorithm. For example, the operations can include a random selection of tokens to be masked out. In some implementations, the masking operations can be performed by a transformer, which is configured to each token with a corresponding positional embedding.

The trained multimodal autoencoder can generate reconstructed data for downstream operations. For example, an image/audio input can be reconstructed using the trained autoencoder with a higher resolution. The reconstructed image or audio data can then be processed by other operations (e.g., generating depth images, image classification, audio separation, etc.) or other analysis (e.g., behavioral analysis, audio-image matching or aligning, etc.)

In addition, the multimodal autoencoder can be trained for performing different technical tasks. For example, a multimodal autoencoder can be trained for performing image-text matching. More specifically, the multimodal autoencoder can be configured to process masked images and masked texts for predicting images with corresponding texts. In some implementations, the multimodal autoencoder can be configured to process textual queries for predicting/generating corresponding images, and vice versa. As another example, a multimodal autoencoder can be trained for performing video-audio fusion. More specifically, the autoencoder can be configured to interpret the video by fusing corresponding audio. Other technical application examples can include audio-text alignment in real time, medical-imaging and patient record matching, video generation based on text or audio, recognizing gestures from video inputs and generating corresponding test for the recognized gestures, or other suitable applications.

After the machine learning model has been trained, the system performs operations to fine-tune the trained machine learning model. For example, the system can receive a plurality of fine-tuning examples, where each fine-tuning example has a portion for the first modality, a portion for the second modality, or both. The system can update the parameters of the encoder by processing each of the plurality of fine-tuning examples using the encoder to generate a prediction and updating the parameters of the encoder by optimizing a second objective function using the predictions and reference outputs. The second objective function can be similar to those suitable objective functions for training the machine learning model.

For example, the trained encoder of one or more modalities in the multimodal autoencoder can be fine-tuned. For image or video modality, the encoder can be fine-tuned for image classification, object detection, transfer learning, or other suitable machine learning tasks. The encoder can be pre-trained on a particular set of images (e.g., animals, human faces, paintings) using a particular backbone machine learning model (e.g., VGG16, ResNet, MobileNet, U-net, Face-net, etc.), the trained encoder can be fine-tuned using other sets of images (e.g., medical images, satellite images, etc.) for performing classification, detection, or fusion within a different context. Similarly, the encoder of audio or textual modalities can be fine-tuned for particular tasks. For example, the encoder of audio modality can be fine-tuned using different audio examples, and the encoder of textual modality can be fine-tuned using different textual examples. Regarding the multimodality fine-tuning, the training process can be similar to the training of the multimodality autoencoder as described above, except that the multimodality fine-tuning is performed on particular training examples that are suitable for the target machine learning tasks.

For any image or video processing task, the encoder may process image data as input. The image data may comprise one or more values for each of plurality of pixels, such as intensity values. Alternatively, the image data may comprise a low-level feature encoding of an image. The image data may comprise color or monochrome data. The image data may captured by an image sensor of a digital camera, LIDAR, infra-red camera or any other camera type. The encoded representation may be further processed by one or more neural network layers to provide an image/video processing output. In an image classification task, the output may be an output indicating the presence of one or more object categories in the input image data. The indication may be a probability, a score or a binary indicator for a particular object category. In an object detection task, the output may be an output indicating a location of one or more objects that have been detected in the input image data. The indication may be a bounding box, set of co-ordinates or other location indicator and the output may further comprise a label indicating the corresponding detected object. In a depth estimation task, the output may be an output indicating an estimated depth of objects depicted in the image data. The output may be a depth map comprising an estimated depth value for each pixel of the input image data. In an image generation task, the neural network may be configured to process input text data to generate image data comprising objects corresponding to the input text data. The output image data may be in a similar format to the input image data for image processing tasks described above.

For any audio processing task, the encoder may be configured to receive and process audio data as an input. The audio data may comprise any type of digital audio signal and may comprise raw digital samples of a waveform (e.g., amplitude values) or maybe an encoding derived from an audio signal such as a spectrogram, mel-frequency cepstral coefficients or other acoustic features/time-frequency domain representation. The audio data may be obtained from an audio transducer such as a microphone. The encoded representation may be further processed by one or more neural network layers to provide an audio processing output. The input audio data may comprise a speech signal. The audio processing task may be a speech processing task such as speech recognition. The output may be output data comprising one or more probabilities or scores indicating that one or more words or sub-word units comprise a correct transcription of the speech contained within. Alternatively, the output data may comprise a transcription itself. The audio processing task may be a keyword (“hotword”) spotting task. The output may be an indication of whether a particular word or phrase is spoken in the input audio data. The audio processing task may be a language recognition task. The output may provide an indication or delineation of one or more languages present in the input audio data. The audio processing task may be control task. The input audio data may comprise a spoken command for controlling a device and the output may comprise output data that causes the device to carry out actions corresponding to the spoken command.

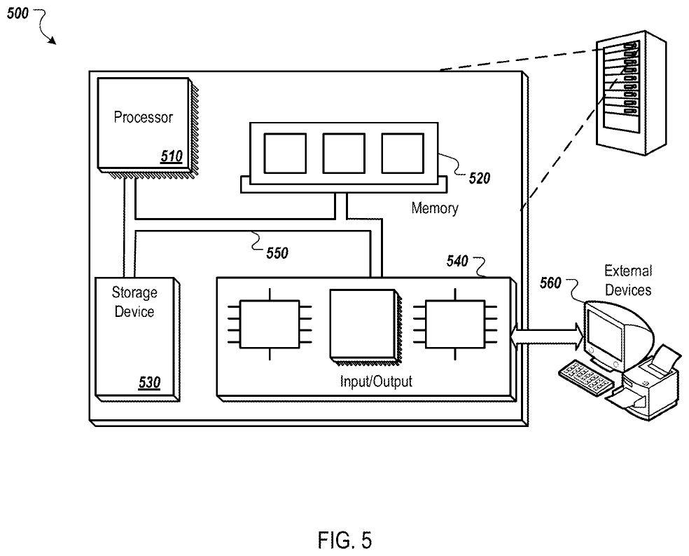

FIG. 5 illustrates a block diagram of an example computer system 500 that can be used to perform the operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In some implementations, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In some implementations, the memory 520 is a volatile memory unit. In another implementation, the memory 520 is a non-volatile memory unit.

The storage device 530 is capable of providing mass storage for the system 500. In some implementations, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In some implementations, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 560, e.g., keyboard, printer and display devices. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:

Clause 1 relates to a method for training a machine learning model, comprising: receiving a plurality of training examples for training a machine learning model, wherein each of the plurality of training examples includes a set of unmasked tokens for a first modality and a set of unmasked tokens for a second modality; for each training example of the plurality of training examples: processing, by an encoder of the machine learning model, the set of unmasked tokens for the first modality of the training example and the set of unmasked tokens for the second modality of the training example to generate a set of embedded tokens for the first modality; processing, by a decoder of the machine learning model, at least the set of embedded tokens for the first modality to reconstruct a set of masked tokens for the first modality; and determining a loss based on the reconstructed set of masked tokens for the first modality and a set of masked tokens for the first modality according to an objective function; optimizing the objective function to decrease the losses for the plurality of training examples; and updating model parameters of the machine learning model based on the optimizing of the objective function.

Clause 2 is the method of clause 1, to generate the plurality of training examples, the method further comprises: receiving a plurality of input examples, wherein each of the plurality of input examples includes a first portion for a first modality and a second portion for a second modality; and generating a training example for each of the plurality of input examples, comprising: masking the first portion of the first modality for the input example to generate the set of masked tokens for the first modality and the set of unmasked tokens for the first modality; and masking the second portion of the second modality for the input example to generate a set of masked tokens for the second modality and a set of unmasked tokens for the second modality.

Clause 3 is the method of clause 1, wherein reconstructing the set of masked tokens for the first modality further comprises: processing, by the decoder of the machine learning model, (i) the set of embedded tokens for the first modality, and (ii) a set of unmasked tokens for the second modality to reconstruct the set of masked tokens for the first modality.

Clause 4 is the method of clause 1, wherein reconstructing the set of masked tokens for the first modality further comprises: processing, by the decoder of the machine learning model, (i) the set of embedded tokens for the first modality, and (ii) a set of embedded masked tokens for the second modality generated by the encoder for the training example to reconstruct the set of masked tokens for the first modality.

Clause 5 is the method of clause 1, wherein the first modality is a video modality and the second modality is an audio modality.

Clause 6 is the method of clause 1, wherein the first modality is an audio modality and the second modality is a video modality.

Clause 7 is the method of clause 2, wherein one of the plurality of input examples includes a video input and a corresponding audio input, wherein the audio input includes a raw audio track or a spectrogram of the raw audio track.

Clause 8 is the method of clause 1, wherein the encoder includes a joint transformer configured to process sets of unmasked tokens for the first modality and corresponding sets of unmasked tokens for the second modality to generate embedded tokens for the first and second modalities.

Clause 9 is the method of clause 1, wherein the encoder includes: a first transformer configured to process sets of unmasked tokens for the first modality to generate embedded tokens for the first modality; and a second transformer configured to process sets of unmasked tokens for the second modality to generate embedded tokens for the second modality.

Clause 10 is the method of clause 1, wherein the encoder includes a transformer with parameters, wherein the transformer is configured to process, for a first time period, sets of unmasked tokens for the first modality using the parameters to update the parameters and generate embedded tokens for the first modality, and the transformer is configured to process, for a second time period, sets of unmasked tokens for the second modality using the updated parameters to update the parameters and generate embedded tokens for the second modality.

Clause 11 is the method of clause 1, wherein the encoder includes: a first transformer to process sets of unmasked tokens for the first modality to generate first intermediate results; a second transformer to process sets of unmasked tokens for the second modality to generate second intermediate results; and a joint transformer to process the first and second intermediate results to generate embedded tokens for the first and second modalities.

Clause 12 is the method of clause 1, wherein the decoder includes a joint transformer configured to process sets of embedded tokens for the first modality and corresponding sets of unmasked tokens for the second modality to reconstruct corresponding sets of masked tokens for the first modality and the second modality.

Clause 13 is the method of clause 1, wherein the decoder includes a first transformer configured to process sets of embedded tokens for the first modality to reconstruct corresponding sets of masked tokens for the first modality, and a second transformer configured to process sets of embedded tokens for the second modality to reconstruct corresponding sets of masked tokens for the second modality.

Clause 14 is the method of clause 1, wherein the decoder includes a transformer with parameters, wherein the transformer is configured to process, for a first time period, sets of embedded tokens for the first modality using the parameters to update the parameters and reconstruct corresponding sets of masked tokens for the first modality, the transformer is configured to process, for a second time period, sets of embedded tokens for the second modality using the updated parameters to update the parameters and reconstruct corresponding sets of masked tokens for the second modality.

Clause 15 is the method of clause 1, wherein the decoder includes: a first transformer to process sets of embedded tokens for the first modality to generate first intermediate reconstruction results; a second transformer to process sets of embedded tokens for the second modality to generate second intermediate reconstruction results; and a joint transformer to process the first and second intermediate reconstruction results to generate corresponding unmasked tokens for the first and second modalities.

Clause 16 is the method of clause 1, wherein the objective function is defined based on one of a Mean-Square-Error (MSE) function, L1 error function, or Huber error function for the first and second modalities.

Clause 17 is the method of clause 2, wherein masking the first portions for the first modality and the second portions for the second modality according to a predetermined algorithm, wherein the masking process further comprises associating each token with a corresponding positional embedding.

Clause 18 is the method of clause 1, after the machine learning model has been trained, further comprising: receiving a plurality of fine-tuning examples, each fine-tuning example including a portion for the first modality, or a portion for the second modality, or both; and updating parameters of the encoder, comprising: processing each of the plurality of fine-tuning examples using the encoder to generate a prediction; and updating the parameters of the encoder by optimizing a second objective function using the predictions and reference outputs.

Clause 19 is a system comprising one or more computers and one or more storage devices storing instructions that, when executed by one or more computers, cause the one or more computers to perform respective operations of any one of clauses 1-18.

Clause 20 is one or more non-transitory computer-readable storage media storing instructions, that when executed by one or more computers, cause the one or more computers to perform respective operations of any one of clauses 1-18.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a machine learning model, comprising:
receiving a plurality of training examples for training a machine learning model, wherein each training example of the plurality of training examples includes a set of unmasked tokens for a first modality and a set of unmasked tokens for a second modality;
for each training example of the plurality of training examples:
processing, by an encoder of the machine learning model, the set of unmasked tokens for the first modality of the training example and the set of unmasked tokens for the second modality of the training example to generate a set of embedded tokens for the first modality;
processing, by a decoder of the machine learning model, at least the set of embedded tokens for the first modality to reconstruct a set of masked tokens for the first modality; and
determining a loss based on the reconstructed set of masked tokens for the first modality and a set of masked tokens for the first modality according to an objective function; and
updating model parameters of the machine learning model by optimizing the objective function to decrease the losses for the plurality of training examples.

2. The method of claim 1, to generate the plurality of training examples, the method further comprises:
receiving a plurality of input examples, wherein each of the plurality of input examples includes a first portion for a first modality and a second portion for a second modality; and
generating a training example for each of the plurality of input examples, comprising:
masking the first portion of the first modality for the input example to generate the set of masked tokens for the first modality and the set of unmasked tokens for the first modality; and
masking the second portion of the second modality for the input example to generate a set of masked tokens for the second modality and a set of unmasked tokens for the second modality.

3. The method of claim 1, wherein reconstructing the set of masked tokens for the first modality further comprises:
processing, by the decoder of the machine learning model, (i) the set of embedded tokens for the first modality, and (ii) a set of masked tokens for the second modality to reconstruct the set of masked tokens for the second modality.

4. The method of claim 1, wherein reconstructing the set of masked tokens for the first modality further comprises:
processing, by the decoder of the machine learning model, (i) the set of embedded tokens for the first modality, and (ii) a set of embedded masked tokens for the second modality generated by the encoder for the training example to reconstruct the set of masked tokens for the first modality or the second modality.

5. The method of claim 1, wherein the first modality is a video modality and the second modality is an audio modality.

6. The method of claim 1, wherein the first modality is an audio modality and the second modality is a video modality.

7. The method of claim 2, wherein one of the plurality of input examples includes a video input and a corresponding audio input, wherein the audio input includes a raw audio track or a spectrogram of the raw audio track.

8. The method of claim 1, wherein the encoder includes a joint transformer configured to process sets of unmasked tokens for the first modality and corresponding sets of unmasked tokens for the second modality to generate embedded tokens for the first modality and the second modality.

9. The method of claim 1, wherein the encoder includes:
a first transformer configured to process sets of unmasked tokens for the first modality to generate embedded tokens for the first modality; and
a second transformer configured to process sets of unmasked tokens for the second modality to generate embedded tokens for the second modality.

10. The method of claim 1, wherein the encoder includes a transformer with parameters, wherein the transformer is configured to process, for a first time period, sets of unmasked tokens for the first modality using the parameters to update the parameters and generate embedded tokens for the first modality, and the transformer is configured to process, for a second time period, sets of unmasked tokens for the second modality using the updated parameters to update the parameters and generate embedded tokens for the second modality.

11. The method of claim 1, wherein the encoder includes:
a first transformer to process sets of unmasked tokens for the first modality to generate first intermediate results;
a second transformer to process sets of unmasked tokens for the second modality to generate second intermediate results; and
a joint transformer to process the first intermediate result and the second intermediate result to generate embedded tokens for the first modality and the second modality.

12. The method of claim 1, wherein the decoder includes a joint transformer configured to process sets of embedded tokens for the first modality and corresponding sets of unmasked tokens for the second modality to reconstruct corresponding sets of masked tokens for the first modality and the second modality.

13. The method of claim 1, wherein the decoder includes a first transformer configured to process sets of embedded tokens for the first modality to reconstruct corresponding sets of masked tokens for the first modality, and a second transformer configured to process sets of embedded tokens for the second modality to reconstruct corresponding sets of masked tokens for the second modality.

14. The method of claim 1, wherein the decoder includes a transformer with parameters, wherein the transformer is configured to process, for a first time period, sets of embedded tokens for the first modality using the parameters to update the parameters and reconstruct corresponding sets of masked tokens for the first modality, the transformer is configured to process, for a second time period, sets of embedded tokens for the second modality using the updated parameters to update the parameters and reconstruct corresponding sets of masked tokens for the second modality.

15. The method of claim 1, wherein the decoder includes:
a first transformer to process sets of embedded tokens for the first modality to generate first intermediate reconstruction results;
a second transformer to process sets of embedded tokens for the second modality to generate second intermediate reconstruction results; and
a joint transformer to process the first intermediate reconstruction result and the second intermediate reconstruction result to generate corresponding unmasked tokens for the first modality and the second modality.

16. The method of claim 1, wherein the objective function is defined based on one of a Mean-Square-Error (MSE) function, an L1 error function, or a Huber error function for the first modality and the second modality.

17. The method of claim 2, wherein masking the first portions for the first modality and the second portions for the second modality according to a predetermined algorithm, wherein the masking further comprises associating each token with a corresponding positional embedding.

18. The method of claim 1, after the machine learning model has been trained, further comprising:
receiving a plurality of fine-tuning examples, each fine-tuning example including a portion for the first modality, or a portion for the second modality, or both; and
updating parameters of the encoder, comprising:
processing each of the plurality of fine-tuning examples using the encoder to generate a prediction; and
updating the parameters of the encoder by optimizing a second objective function using the predictions and reference outputs.

19. A system comprising one or more computers and one or more storage devices storing instructions that, when executed by one or more computers, cause the one or more computers to perform respective operations comprising:
receiving a plurality of training examples for training a machine learning model, wherein each training example of the plurality of training examples includes a set of unmasked tokens for a first modality and a set of unmasked tokens for a second modality;
for each training example of the plurality of training examples:
processing, by an encoder of the machine learning model, the set of unmasked tokens for the first modality of the training example and the set of unmasked tokens for the second modality of the training example to generate a set of embedded tokens for the first modality;
processing, by a decoder of the machine learning model, at least the set of embedded tokens for the first modality to reconstruct a set of masked tokens for the first modality; and
determining a loss based on the reconstructed set of masked tokens for the first modality and a set of masked tokens for the first modality according to an objective function; and
updating model parameters of the machine learning model by optimizing the objective function to decrease the losses for the plurality of training examples.

20. One or more non-transitory computer-readable storage media storing instructions, that when executed by one or more computers, cause the one or more computers to perform respective operations of comprising:
receiving a plurality of training examples for training a machine learning model, wherein each training example of the plurality of training examples includes a set of unmasked tokens for a first modality and a set of unmasked tokens for a second modality:
for each training example of the plurality of training examples:
processing, by an encoder of the machine learning model, the set of unmasked tokens for the first modality of the training example and the set of unmasked tokens for the second modality of the training example to generate a set of embedded tokens for the first modality;
processing, by a decoder of the machine learning model, at least the set of embedded tokens for the first modality to reconstruct a set of masked tokens for the first modality; and
determining a loss based on the reconstructed set of masked tokens for the first modality and a set of masked tokens for the first modality according to an objective function; and
updating model parameters of the machine learning model by optimizing the objective function to decrease the losses for the plurality of training examples.
